(19) United States
(12) Patent Application Publication
(10) Pub. No.: US 2003/0168325 A1
(43) Pub. Date: Sep. 11, 2003

(54) Remote circuit breaker controller for protection and panel labelling

(76) Inventor: Robert G. Egnatovich JR., Atlantic Highlands, NJ (US)

Correspondence Address: Charles I. Brodsky, 2 Bucks Lane, Marlboro, NJ, 07746, US

(21) Appl. No.: 10/092,583

(22) Filed: Mar. 8, 2002

(51) Int. Cl. H01R 24/00

(52) U.S. Cl. 200/51.11

(57) ABSTRACT

A unitary housing including an electrical plug with externally extending prongs for insertion into an outlet or receptacle, an electrical switch in connection therewith, and an indicator of the presence or absence of electrical power applied to the prongs of the plug, with the electrical switch being of an amperage rating greater than that of a circuit breaker protecting the electrical power supply system, such that turning the switch “on”, increases the supplied electrical power to overload the circuit breaker, before overloading the switch.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to the labelling of circuit breaker panels in a home, in general, and to the protected making of electrical repairs there, in particular.

2. Description of the Related Art

As is well known and understood, in making electrical repairs in a home, office or apartment, the most important thing to remember is to first trip the circuit breaker. Oftentimes, however, individual breakers in a panel box are not adequately labelled to identify what rooms, outlets or receptacle are controlled. Typically, some appliance or instrument is connected at an outlet, with the individual breakers then being tripped one-by-one until that breaker is identified which controls the outlet where the test connection is made. The panel box is then labelled, and the repair work begun. Obviously, when trying to make electrical repairs, this back-and-forth search process is time consuming and wasteful. And, even where the panel box is appropriately and sufficiently labelled, the person making the repairs still has to begin by going down into the basement, or into the garage, to turn off the power before starting to work. As will be appreciated, it would be desirable if this all could somehow be simplified.

### SUMMARY OF THE INVENTION

As will become clear from the following description, the present invention allows the individual circuit breaker (whichever one in a panel box it may happen to be) to be tripped remotely from an outlet or receptacle safely, quickly and easily —and without first having to traipse back and forth into the basement or garage to try to determine which breaker is to be switched off, or to turn the appropriately labelled breaker “off” to begin with. As will be seen, the remote circuit breaker controller of the invention comprises a self-enclosed housing which, when plugged into an outlet or receptacle overloads the circuit breaker serving that outlet or receptacle while protecting the worker through the employment of an included electrical switch of amperage rating greater than that of the circuit breaker protecting the power supply. Utilizing an electrical switch of at least a 30 ampere rating (in a preferred embodiment of the invention for example), with a circuit breaker system of 15 ampere rating as found in the typical home, office or apartment, will be seen to lead to the circuit breaker “tripping” before any “shorting” or “sparking” occurs at the inserted outlet.

Thus, and in accordance with this preferred embodiment, the remote circuit breaker controller of the invention includes a 3-prong, 3-terminal electrical plug for connection to the circuit breaker protected power supply through insertion into the outlet where the repair is to take place, or to try to determine the controlling breaker for the location. A 2-position electrical switch also is configured with three terminals which are respectively coupled to those of the electrical plug, with both the plug and the switch being included as part of a unitary housing. Also included with the housing is an indicator of the presence of electrical power at the plug, with the indicator being connected between two of the terminals of the switch. With the control for the switch being externally mounted on the housing, and with the prongs of the electrical plug extending outwardly of the housing into the outlet, flipping the switch to the “on” position short-circuits the power supply, but causes the circuit breaker at the panel box to trip before the switch itself overloads. At the same time, the indicator of the presence of electrical power at the plug switches “off”, from its original display of the presence of power when the electrical switch is in its “off” position. In such configuration, the indicator might include an illuminating light, on one hand, or an electric meter, on the other hand. In all constructions, however, inserting the prongs from the housing into the outlet, followed by positioning the electric switch “on”, serves to overload and “trip” the circuit breaker to that outlet, whichever breaker in the panel box might be the controlling one. The electrical repairs can then be safely made —whether the housing is still inserted into the outlet or not; once the switch is moved back to its “off” position, or the housing is removed from the outlet, the worker can simply go to the circuit breaker panel box, label the tripped breaker accordingly (if it has not previously been done), and then flip the breaker back “on”.

### BRIEF DESCRIPTION OF THE DRAWINGS

These and other features of the present invention will be more clearly understood from a consideration of the following description, taken in connection with the accompanying drawings, in which:

FIG. 1 is an electric circuit diagram, partially in block form, helpful in an understanding of a preferred embodiment of the remote circuit breaker controller of the invention;

FIG. 2 is a simplified side-view of the electrical switch of FIG. 1; and

FIG. 3 is an illustration of a unitary housing in which the electrical plug, the electrical switch, and the indicator of the invention may be enclosed, and from which the prongs of the plug extend outwardly.

### DETAILED DESCRIPTION OF THE INVENTION

In FIG. 3 of the drawings, the unitary housing of the remote circuit breaker controller is shown at 10, with an externally mounted switch control shown at 12. An indicator 14, shown as an illuminating light (but which may alternatively comprise an electric meter instead) serves to indicate the presence of electrical power applied to the externally extending prongs 16, 18, 20 of an electrical plug 25 inserted into an outlet 22 to which power is applied from an electrical power supply 24 protected by an array of circuit breakers 26 included in a remote panel box 28. The “hot” prongs of the electrical plug 25 are those identified at 16, 18, with the ground prong being shown at 20.

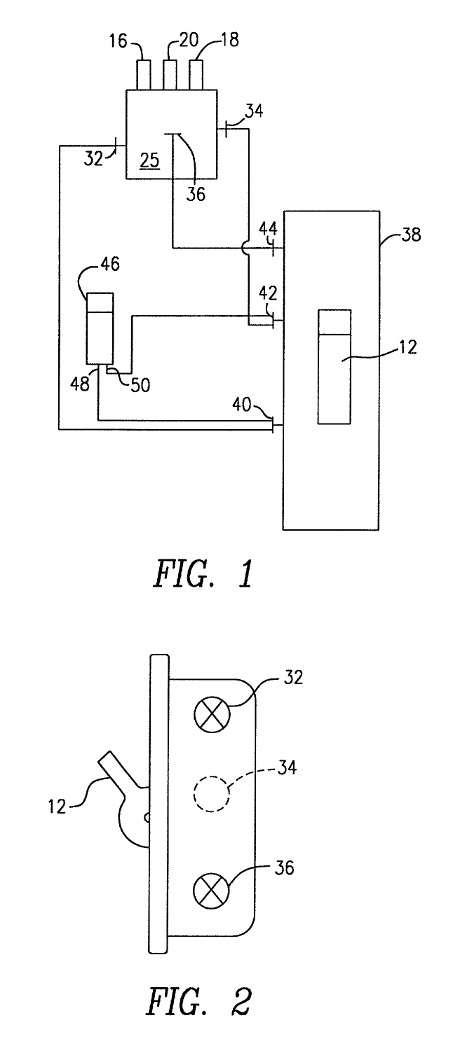

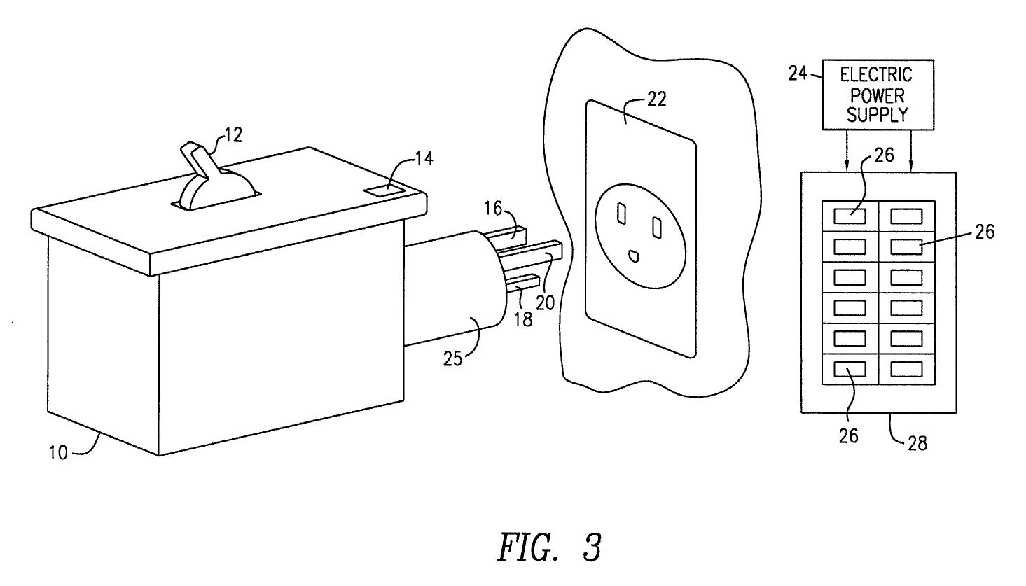

Referring to the circuit diagram of FIG. 1, three terminals for the electrical plug 25 are shown at 32, 34, and 36, connected to the prongs 16, 18, and 20, respectively. The electrical switch controlled at 12 is shown by the reference numeral 38, and includes 3 terminals 40, 42, and 44. As indicated, terminal 32 of the plug 25 is connected to terminal 40 of the switch 38, terminal 34 of the plug 25 is connected to terminal 42 of the switch 38, and terminal 36 of the plug 25 is connected to terminal 44 of switch 38. The indicator 14 of FIG. 3, shown as an illuminating light 46 in FIG. 1, includes two terminals 48 and 50 which, as illustrated, are connected to terminals 40 and 42 of the electrical switch 38, respectively. Although shown schematically in FIG. 1 with the terminals 40, 42 and 44 on the same side of the switch 38, in a typical construction, the terminals on the switch 38 to which the electrical power is coupled are on opposite sides, for purposes of safety, as shown in FIG. 2. With the control 12 placing the electrical switch 38 in its open or “off” condition, with the prongs of the plug 25 inserted into the outlet 22, and with the circuit breaker feeding that outlet closed, electrical power is supplied to the prongs 18 and 20 of the plug 25, and by means of the prong terminals 32, 34 to the indicator 46 which then illuminates. A worker utilizing the unitary housing 10 in this manner thereby is aware that the circuit breaker at the panel box 28 is “on”, and there is power existing at the outlet 22.

Closing the switch 38 to its “on” condition by flipping the control 12, then short-circuits the terminals 40 and 42 on the switch 38 and the terminals 32 and 34 on the plug 25, causing the circuit breaker connected to the outlet 22 to trip-open as the power drain increases, and the indicator 46 to go “off”. However, by having the electrical switch 38 of a greater amperage rating than that of the circuit breaker in the panel box 28, the switch 38 is prevented from sparking, and the worker utilizing the unitary housing is thereby protected. Turning the switch 38 “on” (by flipping the control 12) thereby causes the circuit breaker at the panel box 28 to switch and shut off all power at the outlet 22. Repairs can then be made, and the worker can thereafter return to the panel box, note the breaker that has tripped “off”, label the breaker accordingly as to location —and, having flipped the electrical switch 38 back “off” or the removing the housing 10 from the outlet 22 entirely, is able to turn the breaker at the panel box 28 back “on”, resuming the application of power to the outlet 22 or to the inserted plug 25. In a preferred embodiment of the invention, an electrical switch 38 of at least a 30 ampere rating has proven quite useful with a panel box 28 of 15 ampere rating.

While there have been described what are considered to be preferred embodiments of the present invention, it will be readily appreciated by those skilled in the art that modifications can be made without departing from the teachings herein. For at least such reason, therefore, resort should be had to the claims appended hereto for a true understanding of the scope of the invention.

I claim:

1. The combination comprising:
a 3-prong, 3-terminal electrical plug for connection to an electrical power supply system protected by an included circuit breaker;
a 2-position electrical switch having 3-terminals respectively connected to said 3-terminals of said electrical plug; and
means connected between two of the terminals of said switch for indicating the presence of electrical power at said electrical plug;
wherein said electrical plug, said electrical switch and said indicating means are included as part of a unitary housing in which said switch is enclosed within said housing and actuated from a control externally mounted thereon, wherein said prongs of said electrical plug extend outwardly of said housing from a point within, and wherein said electrical switch is of an amperage rating greater than an amperage rating of said circuit breaker protecting said electrical power supply system.

2. The combination of claim 1 wherein said switch in a first position couples said indicating means with said switch to display a presence of electrical power applied between said prongs of said electrical plug, and wherein said switch in a second position decouples electrical power from said electrical plug. second position decouples electrical power from said electrical plug.

3. The combination of claim 1 wherein said switch in an “off” position couples said indicating means with said switch to display a presence of electrical power applied between said prongs of said electrical plug, and wherein said switch in an “on” position decouples electrical power from said electrical plug.

4. The combination of claim 1 wherein said electrical switch is of at least a 30 ampere rating.

5. The combination of claim 2 wherein said indicating means includes an illuminating light.

6. The combination of claim 2 wherein said indicating means includes an electric meter.
